(19) United States
(12) Patent Application Publication
(10) Pub. No.: US 2025/0156076 A1
(43) Pub. Date: May 15, 2025

(54) LOCAL CACHE FOR MEMORY DEVICES

(71) Applicant: Advanced Micro Devices, Inc., Santa Clara, CA (US)

(72) Inventors: James R. MAGRO, Austin, TX (US); Christopher Edward COX, Folsom, CA (US); Aaron John NYGREN, Boise, ID (US)

(21) Appl. No.: 18/941,799

(22) Filed: Nov. 8, 2024

Related U.S. Application Data
(60) Provisional application No. 63/597,793, filed on Nov. 10, 2023.

(51) Int. Cl. G06F 3/06

(52) U.S. Cl. CPC G06F 3/0611; G06F 3/0656; G06F 3/0673

(57) ABSTRACT

A system and technique for buffering data locally within a memory device to allow access to data associated with multiple different rows within the memory device. The memory device includes memory bank circuitry having memory cells and sense amplifier circuitry coupled to the memory bank circuitry. The memory device further includes buffer circuitry coupled to an output of the sense amplifier circuitry. Further, the memory device includes selection circuitry. The selection circuitry receives a first data signal from the sense amplifier circuitry and a second data signal from the buffer circuitry, and outputs a selected one of the first data signal and the second data signal.

### CROSS REFERENCE TO RELATED APPLICATIONS

This application claims the benefit of U.S. provisional patent application Ser. No. 63/597,793, filed Nov. 10, 2023, which is hereby incorporated herein by reference.

### TECHNICAL FIELD

Examples of the present disclosure generally relate to buffering data locally within a memory device to allow access to data associated with multiple different rows within the memory device.

### BACKGROUND

In modern computer architectures, memory devices including multiple memory cells are used. One example memory device is a dynamic random-access memory (DRAM). A memory device contains a multi-level metric array of memory cells arranged in multiple banks. The memory cells are arranged in rows and columns within the array. A memory controller coupled to the memory cell provides memory commands to the memory device, indicating which memory cells to activate to be read from (e.g., a read command) or to be written to (e.g., a write command). In one example, accessing a row of memory cells for a read command includes precharging a previously accessed row and activating the new target row. The data within the memory cells of an activated row is received by sense amplifiers, and output to the memory controller.

### SUMMARY

In one example, a memory device includes memory bank circuitry having memory cells and sense amplifier circuitry coupled to the memory bank circuitry. The memory device further includes buffer circuitry coupled to an output of the sense amplifier circuitry. Further, the memory device includes selection circuitry. The selection circuitry receives a first data signal from the sense amplifier circuitry and a second data signal from the buffer circuitry, and outputs a selected one of the first data signal and the second data signal.

In one example, a method includes outputting, from sense amplifier circuitry of a memory device, a first data signal based on a first command. The first data signal corresponds to a first one or more memory cells of the memory device. The method further includes outputting, from buffer circuitry of the memory device, a second data signal. The second data signal corresponds to a second command. The second data signal corresponds to a second one or more of the memory cells of the memory device. Further, the method includes outputting, from selection circuitry of the memory device, a selected one of the first data signal and the second data signal.

In one example, a computing system includes a memory controller configured to output a first command and a second command, and a memory device. The memory device includes sense amplifier circuitry, buffer circuitry, and selection circuitry. The sense amplifier circuitry outputs a first data signal based on the first command and a second data signal associated with the second command. The buffer circuitry stores the second data signal based on receiving the second command. The selection circuitry receives the first data signal from the sense amplifier circuitry and the second data signal from the buffer circuitry, and outputs a selected one of the first data signal and the second data signal.

These and other aspects may be understood with reference to the following detailed description.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of a computing system.

FIG. 2 illustrates a block diagram of a memory system.

FIG. 3 illustrates a block diagram of a portion of a memory system.

FIG. 4 illustrates a block diagram of a portion of a memory system.

FIG. 5 illustrates a flowchart of a method for executing read commands within a memory device.

FIG. 6 illustrates a flowchart of a method for operating a memory device.

FIG. 7 illustrates a flowchart of a method for operating a memory device.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Computing systems use memory devices for data storage. The memory devices include multiple memory cells that store values (e.g., bits of data). The memory cells are disposed within an array. In one example, the memory cells are disposed in rows and columns. In other examples, the memory cells are disposed in other configurations. The memory cells store data as voltage values. Further, the memory cells are connected to wordlines and bitlines. In one example, each row memory cells is connected to a respective wordline (or two or more wordlines). The wordlines are driven to select the corresponding memory cells to be written to or read from. The wordlines are coupled to row select circuitry that drives the corresponding wordlines. The bitlines are driven to write a value to a selected memory cell (or memory cells) or electrically floated to read a value from a selected memory cell (or memory cells). The bitlines are coupled to sense amplifier circuitry. The sense amplifier circuitry controls the voltage values of the bit lines to drive data onto select ones of the memory cells or read from selected ones of the memory cells.

In one example, two or more memory cells are grouped together to form a memory bank. In one or more examples, a memory bank includes one or more rows and/or one or more columns of memory cells.

A memory cell includes one or more transistors and one or more capacitors. A memory cell may be referred to as a bitcell. The transistors are coupled to the wordlines and bitlines to control the selection of, writing to, and reading from the memory cells. The one or more capacitors store the value (or a bit) of the memory cell. Writing to a memory cell updates the voltage value of the one or more capacitors

In one example, to read from a row of memory cells, a previously accessed row is precharged and the target row is activated. Precharging a row closes the current row, restoring the value read from row of capacitors of the memory cells, and prepares the sense amplifiers to read another row of memory cells.

Precharging a currently active row of memory cells to activate another row of memory cells may be referred to a row or page conflict. Row or page conflicts use a large number of cycles, increasing the latency of the memory device. The memory device described in the following includes buffer circuitry that stores the data associated with a first active row of memory cells and sense amplifier circuitry that reads data associated with a second row of memory cells. The first row of memory cells are deactivated (e.g., precharged) while the second row of memory cells are activated. The data associated with the first row of memory cells remains in the buffer circuitry while the data associated with the second row of memory cells are activated. Accordingly, data associated with multiple rows of memory cells may be accessed without a row or page conflict occurring. Accordingly, the latency of a memory device is reduced, increasing the performance of the memory device.

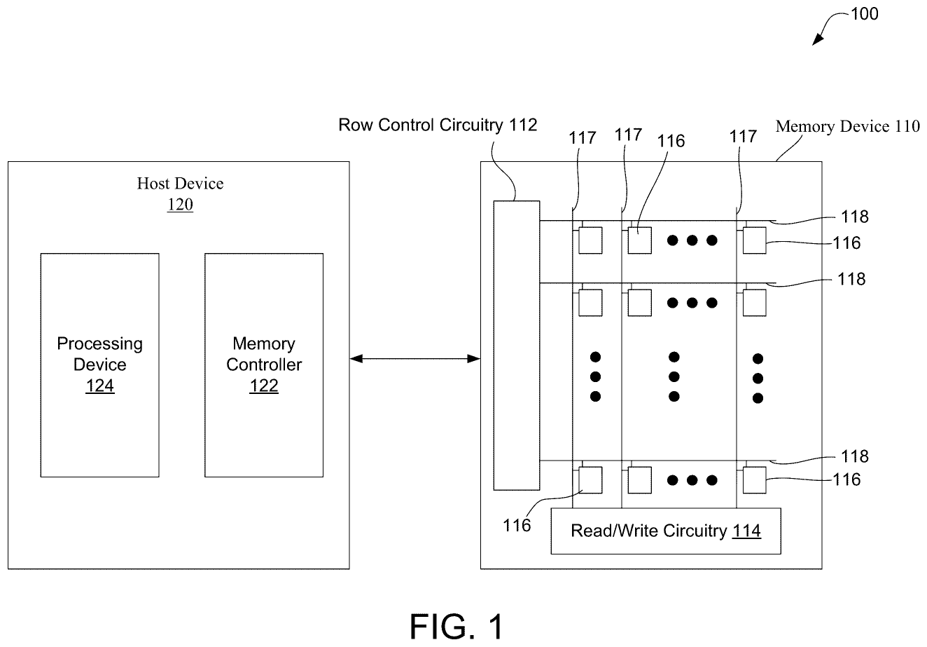

FIG. 1 illustrates a computing system 100 comprising a memory device 110 coupled with host device 120. The host device 120 includes a memory controller 122 and a processing device 124. The processing device 124 is a central processing unit (CPU) or a graphics processing unit (GPU), among others.

In one example, the memory device 110 is a double data rate (DDR) memory device. In one or more examples, the memory device 110 is a DDR1, DDR2, DDR3, DDR4, or DDR5, another type of DDR memory. In other examples, the memory device 110 is another type of memory. In one example or more examples, the memory device 110 is a Dual In-line memory Module (DIMM). In one or more examples, the memory device 110 is a multi-ranked buffered (MR) DIMMs.

The memory device 110 includes row control circuitry 112, read/write circuitry 114, memory cells 116, bitlines 117, and wordlines 118. The memory cells 116 are disposed in an array. For example, the memory cells 116 are disposed in rows and columns. In other examples, the memory cells are disposed in other configurations. In one example, a row (or another grouping) of the memory cells 116 is coupled to a common wordline 118 or two or more wordlines 118. In one or more examples, at least one wordline 118 is coupled to two or more rows (or other grouping) of the memory cells 116. In one example or more examples, a column (or another grouping) of memory cells 116 is coupled to a common bitline 117 or two or more bitlines 117. In one or more examples, at least one bitline 117 is coupled to two or more column (or other grouping) of memory cells 116.

The memory cells 116 include one or more transistors and one or more capacitors. The transistors of a memory cell 116 are connected to the corresponding wordline, or wordlines, 116, and to the corresponding bitline, or bitlines 117. The transistors control the activation or deactivation of the corresponding memory cell 116 based on the voltage values of the corresponding wordline, or wordlines, 118, and the corresponding bitline, or bitlines, 117. The capacitor, or capacitors, of the memory cell 116 store the value of the memory cell 116. In one example, the capacitor, or capacitors, of an activated memory cell 116 are updated with a value or a value is read from the capacitor, or capacitors, of an activate memory cell 116.

The row control circuitry 112 is connected to the wordlines 118. The row control circuitry 112 is coupled to the memory cells 116 via the wordlines 118.

The row control circuitry 112 controls the activation and deactivation of the memory cells 116 by controlling how the corresponding wordlines 118 are driven. In one example, one or more memory cells 116 are activated for updating by driving a predetermined voltage level, or levels, on the corresponding one or more wordlines 118.

In on example, the row control circuitry 112 receives one or more signals (e.g., address signals, control signals, and/or data signals, among others) that indicate which of the wordlines 118 to drive to active a corresponding one or more of the memory cells 116.

The read/write circuitry 114 is connected to the bitlines 117. In one example, the read/write circuitry 114 is connected to the memory cells 116 via the bitlines 117. In one example, the read/write circuitry 114 drives one or more of the bitlines 117 to update a value of a corresponding memory cell 116 and/or read a value from a corresponding memory cell 116. In one example, the read/write circuitry 114 includes sense amplifier circuitry that is connected to the bitlines 117 and is configured to receive a signal from the memory cells 116 via the bitlines 117 and/or write a value to the memory cells 116 via the bitlines 117.

In on example, the read/write circuitry 114 receives one or more signals (e.g., address signals, control signals, and/or data signals, among others) that indicate which of the bitlines 117 to drive to active a corresponding one or more of the memory cells 116 for updating or to be read from.

The memory controller 122 communicates address signals, control signals and data signals to the memory device 110. The processing device 124 provides data signals to the memory controller 122. The memory controller 122 generates control and address signals associated with the data signals. The memory controller 122 receives data signals from the memory device 110. The memory device 110 generates the data signals based on the address and/or control signals generated and output by the memory controller 122.

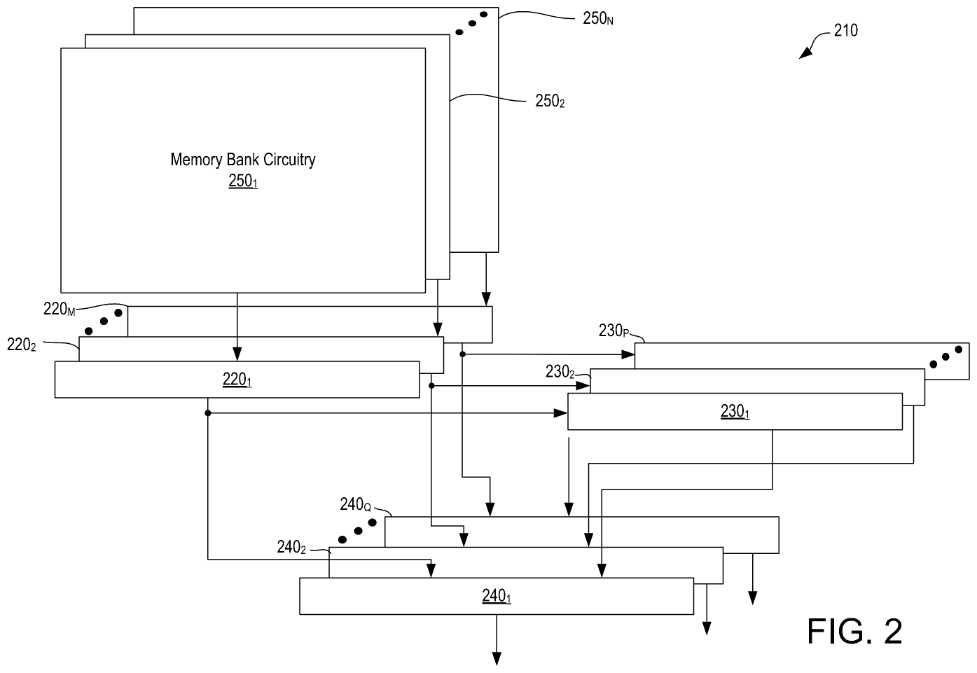

FIG. 2 illustrates an example of the memory device 210. The memory device 210 is configured similar to the memory device 110 of FIG. 1. The memory device 210 includes memory bank circuitries 250, sense amplifier circuitries 220, buffer circuitries 230, and selection circuitries 240. Each of the memory bank circuitries 250 includes one or more memory cells (e.g., one or more of the memory cells 116 of FIG. 1). In one example, each of the memory bank circuitries 250 includes a different one or more memory cells (e.g., a different one or more of the memory cells 116 of FIG. 1). The sense amplifier circuitries 220 are included within read/write circuitry (e.g., the read/write circuitry 114 of FIG. 1). In one example, the buffer circuitries 230 are included within the read/write circuitry (e.g., the read/write circuitry 114 of FIG. 1) or in a circuit element of the memory device 210, external to the read/write circuitry. In one example, the selection circuitries 240 are included within the read/write circuitry (e.g., the read/write circuitry 114 of FIG. 1) or in a circuit element of the memory device 210, external to the read/write circuitry. In one or more examples, the sense amplifier circuitries 220, the buffer circuitries 230, and the selection circuitries 240 are included within the read/write circuitry (e.g., the read/write circuitry 114 of FIG. 1). In another example, one or more of the sense amplifier circuitries 220, the buffer circuitries 230, and the selection circuitries 240 is included within the read/write circuitry (e.g., the read/write circuitry 114 of FIG. 1) and one or more of the sense amplifier circuitries 220, the buffer circuitries 230, and the selection circuitries 240 is included within a circuit element of the memory device 210 external to the read/write circuitry (e.g., the read/write circuitry 114 of FIG. 1).

The memory device 210 includes memory bank circuitries 250₁-210_{N}. N is two or more. Each memory bank circuitry 250 is coupled to a respective sense amplifier circuitry 220 and a respective buffer circuitry 230. For example, the memory bank circuitry 250₁ is coupled to the sense amplifier circuitry 220₁ and the buffer circuitry 230₁. The sense amplifier circuitry 220₁ and the buffer circuitry 230₁ are coupled to the selection circuitry 240₁. The memory bank circuitry 250₂ is coupled to the sense amplifier circuitry 220₂ and the buffer circuitry 230₂. The sense amplifier circuitry 220₂ and the buffer circuitry 230₂ are coupled to the selection circuitry 240₂. The memory bank circuitry 250_{N} is coupled to the sense amplifier circuitry 220_{N} and the buffer circuitry 230_{N}. The sense amplifier circuitry 220_{N} and the buffer circuitry 230_{N} are coupled to the selection circuitry 240_{N}.

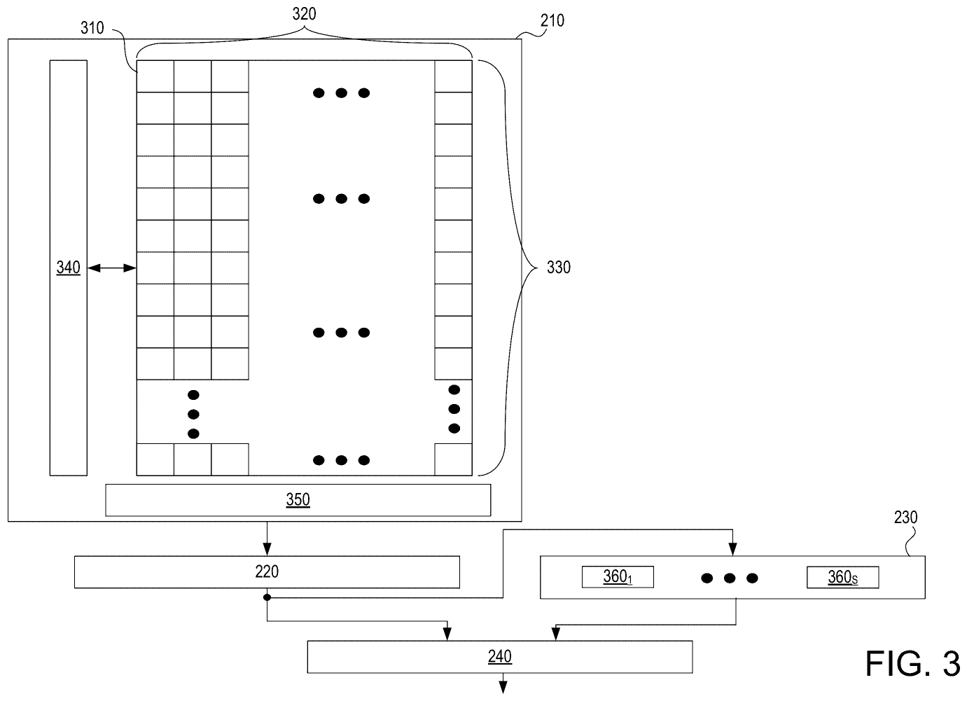

As illustrated in the example of FIG. 3, the memory bank circuitry 250 includes memory cells 310 disposed in columns 320 and rows 330. The memory cells 310 are configured similar to the memory cells 116 of FIG. 1. The memory bank circuitry 250 includes two or more columns and/or two or more rows 330 (or other configuration of memory cells). Further, the memory bank circuitry 250 includes two or more memory cells 310. Each row 330 includes two or more memory cells 310. Each column includes two or more memory cells 310.

The memory bank circuitry 250 further includes row control circuitry 340 and column control circuitry 350. The row control circuitry 340 is configured similar to the row control circuitry 112 of FIG. 1. The row control circuitry 340 is connected to the rows 330. Each row 330 is connected to the row control circuitry 340 via a wordline (e.g., the wordlines 118 of FIG. 1). The row control circuitry 340 selects and activates the memory cells 310 of the rows 330 based on control and/or address signals received from the host device 120. The column control circuitry 350 is coupled to the columns 320 via bitlines (e.g., the bitlines 117 of FIG. 1). The column control circuitry 350 controls the selection of the columns 320 by driving the bitlines with voltage signals. The bitlines are associated with the columns 320.

The columns 320 are coupled to the sense amplifier circuitry 220 via the column control circuitry 350. For example, the memory cells 310 of the columns 320 are coupled to the sense amplifier circuitry 220 via bitlines. In one example, the sense amplifier circuitry 220 receives data from the memory cells 310 via the bitlines.

Each of the sense amplifier circuitries 220 includes one or more sense amplifiers. The memory device 210 includes sense amplifier circuitries 220₁-220_{M}. M is two or more. In one example, M is equal N. In other examples, M is greater or less than N. The sense amplifier circuitries 220 include sense amplifiers that sense a voltage on the memory cells (e.g., the memory cells 310 of FIG. 3) corresponding to data on the memory cells, amplifies the voltage of the memory cells, and/or precharge the memory cells to deactivate the memory cells. The memory cells (e.g., the memory cells 310 of FIG. 3) include one or more transistors and one or more capacitors. The transistors are coupled to the bitlines and wordlines to control selection of the memory cells, and the one or more capacitors store voltage values associated with the data stored in the memory cells. The sense amplifiers of the sense amplifier circuitries 220 sense and amplify the voltage on the memory cells and output the voltages to the selection circuitry 240.

The output of each sense amplifier circuitry 220 is coupled to a respective one of the buffer circuitries 230 and the selection circuitry 240. The memory device 210 includes buffer circuitries 230₁-230_{P}. P is two or more. P is greater than or less than M and/or N. Further, the memory device 210 includes selection circuitries 240₁-240_{Q}. Q is two or more. Q is greater than or less than M, N, and/or P.

In one example, the memory device 210 includes a single buffer circuitry 230. In such an example, each of the sense amplifier circuitries 220 is coupled to the same buffer circuitry 230. In other examples, N is greater than P. In such an example, two or more of the sense amplifier circuitries 220 are coupled to the same buffer circuitry 230.

In one or more examples, the output of the sense amplifier circuitry 220₁ is coupled to the buffer circuitry 230₁ and the selection circuitry 240₁, the output of the sense amplifier circuitry 220₂ is coupled to the buffer circuitry 230₂ and the selection circuitry 240M, and the output of the sense amplifier circuitry 220_{M} is coupled to the buffer circuitry 230_{P} and the selection circuitry 240_{Q}.

The sense amplifier circuitry 220 outputs a data signal to a buffer circuitry 230, and the buffer circuitry 230 stores the data of the data signal. The data signal is associated with an activated row 330. Each buffer circuitry 230 includes one or more latches and/or one or more flip-flops. In other examples, a buffer circuitry 230 includes sense amplifiers and configured similar to a sense amplifier circuitry 220. In other examples, a buffer circuitry 230 includes other types of memory elements. In one example, a buffer circuitry 230 is configured to store data associated with a row (e.g., row 330) of a memory bank circuitry 250.

The buffer circuitry 230 is configured to store one or more bits of a page. A page corresponds to one or more memory cells of a memory bank circuitry 250. In one example, a page corresponds to a row of memory cells. In one example, a buffer circuitry 230 is configured to store a fraction (e.g., ½, ¼, ⅛, or 1/T, where T is greater than 8) of a page.

In one or more examples, one or more buffer circuitry 230 stores data associated with multiple rows of memory cells (e.g., rows 330 of FIG. 3). As is illustrated in FIG. 3, the buffer circuitry 230 includes multiple row buffer circuitries 360. In one example, the buffer circuitry 230 includes the row buffer circuitries 350₁-350_{S}. S is two or more. Each row buffer circuitry is configured to store data associated with one or more rows 330 of memory cells 310.

A selection circuitry 240 is a multiplexer (MUX). In other examples, the selection circuitry is another type of selection circuitry. A selection circuitry 240 has a first input coupled to an output of a respective sense amplifier circuitry 220 and an output of a respective buffer circuitry 230. For example, a first input of the selection circuitry 240₁ is coupled to the output of the sense amplifier circuitry 220₁ and a second input of the selection circuitry 240₁ is coupled to the output of the buffer circuitry 230₁. Further, a first input of the selection circuitry 240₂ is coupled to the output of the sense amplifier circuitry 220₂ and a second input of the selection circuitry 240₂ is coupled to the output of the buffer circuitry 230₂.

A selection circuitry 240 receives a first data signal from a respective sense amplifier circuitry 220 and a second data signal from a respective buffer circuitry 230, and outputs one of the first and second data signals based on a control signal. The control signal is provided by a memory controller (e.g., the memory controller 122 of FIG. 1).

In one example, the memory device 210 receives one or more command signal or signals from a host device (e.g., the host device 120). A command signal is may be a read command signal (e.g., read operation) or a write command signal (write operation). Further, a command signal may indicate an address within the memory bank circuitry 250 that is a target address where data is written to or data is read from. In one example, the command signal may be decoded to indicate a column 320 and row 330 of a particular memory bank circuitry 250 to activate to execute the command signal.

In one example, the command signal includes an indication (e.g., one or more values) that are used to determine if data is selected and output from a sense amplifier circuitry 220 or a buffer circuitry 230. For example, the command signal may include an encoded value that is decoded by the memory device 210. The decoded value is provided to the selection circuitries 240 to determine if a value or values read from the memory bank circuitries 250 is selected and output from the sense amplifier circuitry 220 or one of the buffer circuitry 230. The decoded value is provided as a control signal to the selection circuitries 240. In one example, the command signal is a command address strobe (CAS) command signal that includes an encoded value that indicates whether to select and output a value or values received from the sense amplifier circuitries 220 or the buffer circuities 230.

The outputs of the selection circuitries 240 are coupled to the host device 120. For example, the outputs of the selection circuitries 240 are coupled to the memory controller 122, and output data signals to the memory controller 122. In one example the outputs of the selection circuitries 240 are coupled to a first-in, first-out (FIFO) buffer circuit within a read data path circuitry of a memory device. The FIFO buffer is coupled to the memory controller 122. In one example, driver circuitry is used to drive the data signal to the memory controller 122.

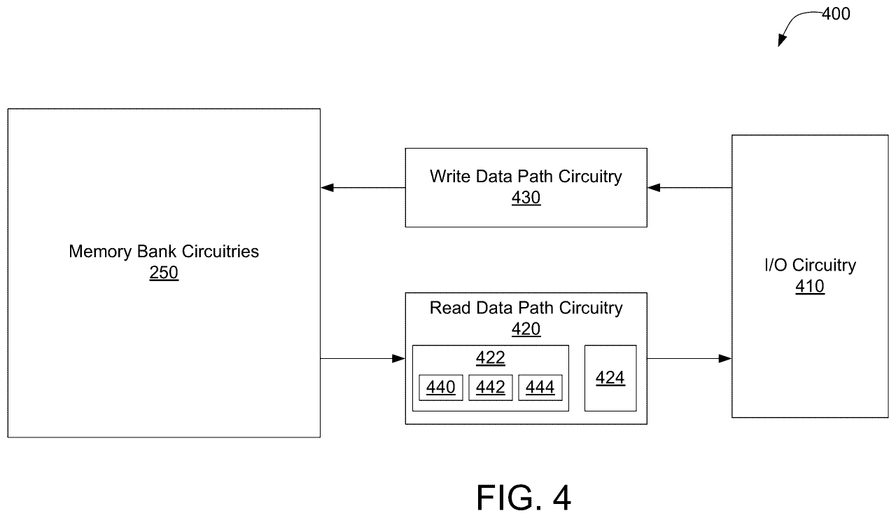

FIG. 4 illustrates a memory device 400. The memory device 400 includes input/output (I/O) circuitry 410, read data path circuitry 420, write data path circuitry 430, and the memory bank circuitries 250. The I/O circuitry 410 is coupled to the memory bank circuitries 250 via the read data path circuitry 420 and the write data path circuitry 430. The I/O circuitry 410 receives data from a memory controller (e.g., the memory controller 122 of FIG. 1) to be written to the memory bank circuitries 250, and provides the data to the memory bank circuitries 250 via the write data path circuitry 430. The write data path circuitry 430 includes desterilize circuitry, one or more flipflops, and alignment circuitry, among others. In one example, write driver circuitry coupled to the memory bank circuitries 250 receive the data signal, and drives the data signal onto activated memory cells, to update the memory cells.

The memory bank circuitries 250 outputs data to the I/O circuitry 410 via the data path circuitry 420, which outputs the data to a memory controller (e.g., the memory controller 122 of FIG. 1). In one example, sense amplifier circuitry (e.g., the sense amplifier circuitry 220) obtains data from one or more memory cells (e.g., the memory cells 310 of FIG. 3). The sense amplifier circuitry outputs the data to the I/O circuitry 410 via the read data path circuitry 420.

In one example, the read data path circuitry 420 includes a read buffer circuitry 422 and driver circuitry 424. The read buffer circuitry 422 receives data signals from the sense amplifier circuitries and communicates the data signals to the driver circuitry 424 that outputs the data signal to the I/O circuitry 410. In one example, the driver circuitry 424 is serializer circuitry.

In one example, the buffer circuitry 422 includes buffer circuitries 440, buffer circuitries 442, and selection circuitries 444. The buffer circuitries 440 and the buffer circuitries 442 function similar to and are configured similar to the buffer circuitries 230 of FIG. 2. For example, the buffer circuitries 440 and 442 each store data associated with one or more rows of the memory bank circuitries 250. In one example, the buffer circuitries 440 stores data associated with a first row and the buffer circuitries 442 store data associated with a second row. The first row corresponds to a currently active row within the memory bank circuitries 250, and the second row corresponds to a non-active row (e.g., a previously active row that is now deactivated). The outputs of the buffer circuitries 440 and 442 are connected to the selection circuitry 444. The selection circuitry 444 is configured similar to the selection circuitry 240. In one example, the selection circuitry 444 outputs a data signal from one of the buffer circuitries 440 and 442 based on a control signal provided by a memory controller (e.g., the memory controller 122). Accordingly, in such a configuration data corresponding to a currently active row of memory cells and data corresponding to a previously active row of memory cells can be output to a host device (e.g., the host device 120 of FIG. 1).

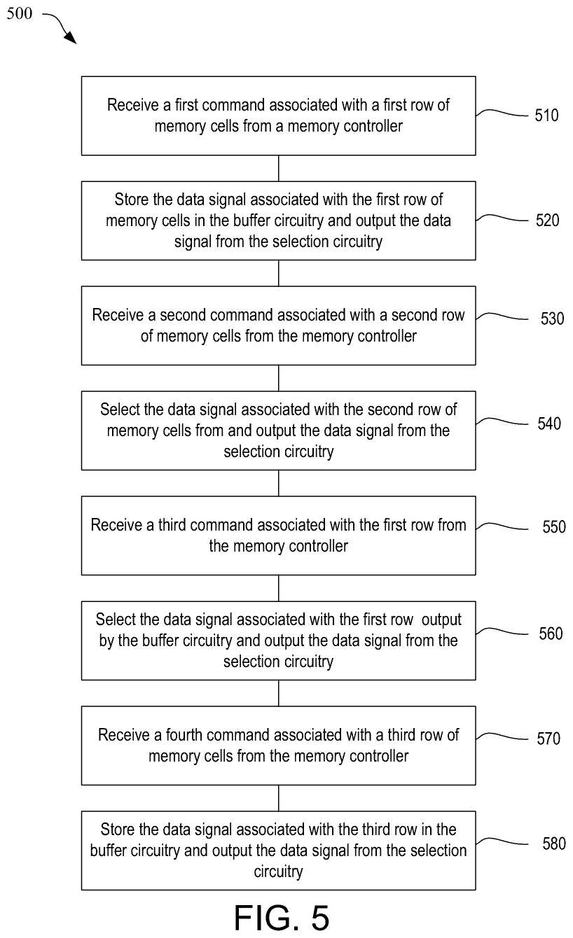

FIG. 5 illustrates a flowchart of a method 500 for accessing a memory device, according to one or more examples. The method 500 is performed by the memory device 210 and a host device (e.g., the host device 120 of FIG. 1). At operation 510, a first command signal associated with a first row is received from a memory controller (e.g., the memory controller 122). In one example, the memory controller 122 generates a command signal based on a control signal received from the processing device 124. The command signal may be an ACTIVATE command signal. The ACTIVATE command signal is part of a read or write memory operation. The ACTIVATE command is a row access command. In one example, the ACTIVATE command activates (e.g., opens up or selects) a row (e.g., a row 330) and outputs (e.g., pulls) the data (e.g., charge) to the sense amplifier circuitry 220. The data can be output from the sense amplifier circuitry 220 to a buffer circuitry 230. In another example, the ACTIVATE command activates a row (e.g., a row 330) and the data is pulled to the sense amplifier circuitry 220. A read command is used to output the data from the sense amplifier circuitry 220 to the buffer circuitry 230.

In one example, the command signal includes a plurality of bits that indicate a target address within the memory device 210 and one or more control values. The control values are indicated via one or more bits. The one or more bits may be used to determine if data is to be stored within the buffer circuitry 230, and/or selected and output from a sense amplifier circuitry 220 or the buffer circuitry 230. In one example, the one or control bits may indicate which of the buffer circuitries 230 to store the data. In one example, the memory controller 122 outputs one or more controls signals having one or more bits in addition to the command signal. The one or more bits indicate whether the data associated with the command signal is to be stored within the buffer circuitry 230 of FIG. 2 and control of the selection circuitry 240. In one example, the one or more bits may indicate which of the buffer circuitries 230 to store the data.

In one example, a buffer circuitry 230 is a fraction of the size of a page (e.g., able to store a fraction of a row or rows of a memory bank). In such an example, the one or more bits include an indication as to the number of bits of a page (or row) to store within the buffer circuitry 230. In one or more examples, the one or more bits indicates to load a number of bits starting from a first or last bit of associated with a command signal.

In one example, the one or more bits include a specific portion of a page (or row) that is to be stored within a buffer circuitry 230. For example, a page within a memory bank circuitry 250 is divided into multiple portions. The one or more bits indicate which of the portions to be stored within a buffer circuitry 230. In one example, the portion of the page that is to be stored within the buffer circuitry 230 corresponds to the portion of the page where the address information associated with the command signal is stored. For example, the address information associated with a command signal is stored within the third portion (e.g., third ⅛^{th}) of a page of a memory bank. In such an example, the third portion of the page is stored within the buffer circuitry 230.

The memory device 210 receives the command signal and activates a first row 330 within a first memory bank circuitry 250 associated with the address of the read command. The sense amplifier circuitry 220 generates and output data signals from the voltages within the activated row or the corresponding portion of the activated row. In one example the active row is referred to as a first row.

In one example, the memory controller 122 maintains a page table, indicating the data of the rows or portion of rows stored within the buffer circuitries 230. Further, in one or more example, the memory controller 122 reorders the commands, such that commands to a common row occur in order with each other. The memory controller 122 generates control signals based on the target row of a command and the data stored within the buffer circuitry 230. For example, based on a determination as to whether or not the data associated with the target row is stored within the buffer circuitry 230 or not. Based on the data being stored in the buffer circuitry 230, the memory controller 122 generates a control signal that provides an indication to the selection circuitry to select the output of the buffer circuitry 230 for outputting. Based on the data not being stored in the buffer circuitry 230, the memory controller 122 generates a control signal that provides an indication to the selection circuitry 240 to output the data signal output from the sense amplifier circuitry 220. The memory controller 122 may additionally generate one or more bits of a command signal or a control signal that provides an indication to the buffer circuitry 230 to store the data signal or to not store the data signal. In one example, the data is not stored in the buffer circuitry 230 to maintain the current data in the buffer circuitry 230 that is the target of a subsequent memory command. In an example, where the buffer circuitry 230 includes multiple row buffer circuitries 360, the one or more bits or control signal may indicate which row buffer circuitry 360 to output a data from and/or in which row buffer circuitry 360 to store data.

In one example, an indication (e.g., one or more values) is included within one or bits of a command signal or a control signal. The indication is used to determine if data is selected and output from the sense amplifier circuitries 220 or the buffer circuitry 230.

At operation 520, a data signal associated with the first row of memory cells is stored within the buffer circuitry and the data signal is output from the selection circuitry. In one example, one or more control signals are sent with the read command from the memory controller 122 to the memory device 210. The one or more control signals includes one or more bits that provide an indication to the buffer circuitry 230 to store the data signal associated with the first row. The one or more control signals are received by the buffer circuitry 230. The buffer circuitry 230 determines whether or not to store the data signal received from the sense amplifier circuitry 220. In one example, the buffer circuitry 230 receives the data signal from the sense amplifier circuitry and a control signal, and stores the data of the data signal within the buffer circuitry 230 based on value of the bits in the control signal. The data signal includes data (e.g., voltage value of bits) associated with an entire page (row) or a portion of the page. In one or more examples, storing the data of the data signal within the buffer circuitry 230 includes storing the data of the data signal within the row buffer circuit 3601 of the buffer circuitry 230.

The data signal associated with the first row (or portion of the first row) is further output to the selection circuitry 240. The selection circuitry 240 outputs the data signal to the memory controller 122 via a read data path and/or other output circuitry of the memory device 210. In one example, the one or more control signals are further received by the selection circuitry 240 from the memory controller 122. The one or more control signals provide an indication to the selection circuitry 240 to select and output the data signal received from the sense amplifier circuitry 220 or a data signal received from the buffer circuitry 230. The value of the one or more control signals determines which data signal is output by the selection circuitry 240.

At operation 530, a second command associated with a second row is received from the memory controller. For example, the memory device 110 receives the second command. Further, a second one or more control signals are output from the memory controller 122 to the memory device 110. In one or more examples, the memory bank circuitry 250 selects and activates a second row 330 of the memory cells 310 based on the second command. The first row is precharged and deactivated, such that the second row can be selected and activated. The sense amplifier circuitry 220 generates second data signals based on the data within the memory cells of the second row. The second data signals are output from the sense amplifier circuitry 220. In one example, data associated within the first row of the memory cells and stored in the buffer circuitry 230 is accessible while the data associated with the second command is obtained and in the source amplifier circuitries at the operation 530 of the method 500.

In one or more examples, at least a portion of the operation 520 of the method 500 and the operation 530 of the method 500 may occur during at least partially overlapping periods. In one example, at least a portion of the operation 520 of the method 500 and the operation 530 of the method 500 occur in parallel. Stated another way, in one or more examples, first data is able to be read from the buffer circuitry 230 at the operation 520 of the method 500 while second data is loaded into the sense amplifier circuitries 220 at the operation 530 of the method 500. In one or more examples, the operation 520 of the method 500 and the operation 530 of the method 500 occur during non-overlapping periods.

The buffer circuitry 230 receives the second one or more controls signals and determines whether or not to store the data associated with the second data signal. In one example, based on the values of the bits of the second one or more control signals, the buffer circuitry 230 determines to not store the data associated with the second data signal. In such an example, the memory controller 122 generates a control signal with the indication to not store the data of the second data signal as a pending read command has the data of the first data signal as a target. Accordingly, when the pending command is executed, the data of the first data signal can be read from the buffer circuitry 230.

In one example, the buffer circuitry 230 stores the second data signal in a second row buffer circuit 3302 based on the second one or more control signals.

At operation 540, a data signal associated with the second row of the memory cells is selected output by the selection circuitry. In one example, the selection circuitry 240 receives the second data signal from the sense amplifier circuitry 220 and the first data signal from the buffer circuitry 230 and the second one or more control signals. Based on the value of the second one or more control signals, the selection circuitry 240 selects and outputs one of the second data and the first data signal. In one example, the control signal is associated with the second command, accordingly, the selection circuitry 240 selects and outputs the second data signal from the sense amplifier circuitry 220, as the second data signal includes the data associated with a second row 330, which is the target of the second read command.

At operation 550, a third command associated with the first row is received from the memory controller. The memory controller 122 outputs the third command with a third one or more control signals to the memory device. The third one or more control signals include an indication to the selection circuitry to select the data signal output from the buffer circuitry 230. Further, the third one or more control signals provide an indication to the memory bank circuitry 250 and the sense amplifier circuitry 220 to maintain the currently activated second row as ab activated row.

At operation 560, the data associated with the first row of the memory cells output by the buffer circuitry is selected and output by the selection circuitry. The selection circuitry 240 receives a data signal from the sense amplifier circuitry 220, a data signal from the buffer circuitry 230, and the third one or more of the control signals. Based on the value of the control signal, the selection circuitry 240 selects and outputs the data signal received from the buffer circuitry 230.

In one example, the buffer circuitry 230 receives third one or more control signals, and selects and outputs data from one of the row buffer circuitries 360 that is associated with the received read command.

At operation 570, a fourth command associated with the second row of the memory cells is received from the memory controller. The memory bank circuitry 250 receives the fourth command and deactivates the second row of memory cells by precharging the second row of memory cells based on a control signal received from the memory controller 122. Further, the third row is activated. The sense amplifier circuitry 220 receives the data associated with the memory cells of the third row, and generates a data signal.

At operation 580, the data associated with the third row of the memory cells is stored within the buffer circuitry and output from the selection circuitry. In one example, the buffer circuitry 230 receives a control signal from the memory controller 122 and the data signal from the buffer circuitry 230, and stores the data of the data signal within buffer circuitry 230. In one or more examples, the buffer circuitry 230 writes over data within the buffer circuitry 230 with the data of the data signal associated with the third row. In one example, the buffer circuitry 230 stores the data of the data signal within a row buffer circuitry 360 based on the third one or more control signals. Further, the selection circuitry selects and outputs the data signal output from the sense amplifier circuitry 220 based on the third one or more control signals received by the memory controller 122.

In one example, when the memory controller 122 determines that the data of a target row of a read command is within the sense amplifier circuitry 220 and/or the buffer circuitry 230, a page hit is determined. A page hit allows for data associated with a target row of a read command to be output from a memory device without precharging a row (deactivating a row) and activating a new row. Accordingly, the latency of the memory device is reduced as compared to memory devices that do not include buffer circuitry. In one example, the memory controller 122 reorders pending read commands based on the data stored within the buffer circuitry 230.

While the above description is directed to executing read commands, in other examples, the buffer circuitries 230 may be used to execute write commands. In one example, the data signals within the buffer circuitries 230 is maintained, while one or more rows 330 of the memory cells 310 are written, updated, with a data signal. In one example, when a row 330 within the memory bank circuitry 250 is written to, and data associated with the row is stored in the buffer circuitry 230, the buffer circuitry 230 evicts that data and the row is updated in the memory bank circuitry 250. A control signal provided by the memory controller 122 may provide an indication for the buffer circuitry 230 to evict data associated with a row. In another example, a write command includes updating data within the buffer circuitry 230 that is associate with a target row of a write command. The data is then written from the buffer circuitry 230 to the memory cells 310 of the memory bank circuitry 250. Controls signals provided by the memory controller 122 are used to control the writing of data to the buffer circuitry 230 and the writing of data from the buffer circuitry 230 to the memory cells 310.

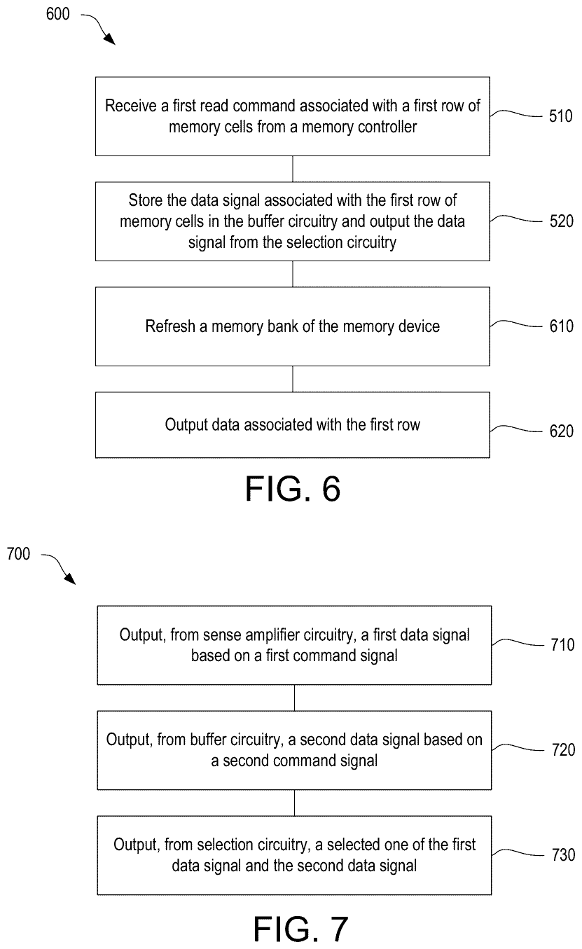

FIG. 6 illustrates a flowchart of a method 600 for operating a memory device (e.g., the memory device 110 of FIG. 1 and/or the memory device 210 of FIG. 2). The method 600 includes operation 510, receiving a first read command associated with a first row of memory cells from a memory controller. The operation 510 is described in greater detail with regard to FIG. 5 above. Further, the method 600 includes operation 520, storing the data associated with the first row of memory cells in the buffer circuitry and output the data signal from the selection circuitry. The operation 520 is described in greater detail with regard to FIG. 5 above. The method 600 further includes operation 610, refreshing one or more cells of the memory device. For example, one or more of the memory cells 116 of FIG. 1 are refreshed. Refreshing a memory cell includes refreshing the stored data (e.g., values) within the memory cell. In one or more examples, a memory cell experience leakage (e.g., charge leakage within the corresponding capacitors). Overtime, the leakage may cause data within a memory cell to be lost. During a refresh process, one or more memory cells 116 are selected and driven with the original values stored within the memory cells via the row control circuitry 112 and the read/write circuitry 114, refreshing the values of the selected memory cells 116. With reference to FIG. 2, the memory refresh process may be applied to one or more of the memory bank circuitries 250. In other examples, the memory refresh process is applied to one or more ranks of a memory device.

At operation 620 of the method 600, the data associated with the first row is output. For example with reference to FIG. 2, the selection circuitry 240 selects the data from the buffer circuitry 230 to be output. As the selection circuitry 240 selects the data from the buffer circuitry 230 to be output, the sense amplifier circuitry 220 can be used to refresh the memory bank circuitry 250 (e.g., refresh one or more memory cells 116 of FIG. 1). Accordingly, data can be selected and output from the buffer circuitries 230 while one or more of the memory bank circuitries 250 are refreshed. In one example, one or more of the memory bank circuitries 250 (or one or more memory cells 116 of FIG. 1) are refreshed via the sense amplifier circuitries 220 and data is selected and output from one or more of the buffer circuitries 230 via the selection circuitries 240 during at least partially overlapping periods. In one example, one or more of the memory bank circuitries 250 (or one or more memory cells 116 of FIG. 1) are refreshed via the sense amplifier circuitries 220 and data is selected and output from one or more of the buffer circuitries 230 via the selection circuitries 240 concurrently. Accordingly, data according to one or more memory cells and/or rows of a memory device (e.g., the memory device 210) is output based on a read command from the buffer circuitry 230 during a period that at least partially overlaps with a period when the one or more memory cells and/or rows of a memory device are refreshed.

In one example, operation 610 and operation 620 of the method 600 occur during at least partially overlapping periods. In one example, operation 610 and operation 620 occur in parallel with each other. In examples where operations 610 and 620 occur during at least partially overlapping periods or in parallel with each other, data can be read from the buffer circuitry 230 while a corresponding memory bank circuitry refreshed via refresh cycle where data access is normally be blocked. In other, example, operation 610 may occur before or after operation 620.

FIG. 7 illustrates a flowchart of a method 700 for operating a memory device (e.g., the memory device 110 of FIG. 1 and/or the memory device 210 of FIG. 2). At operation 710 of the method 700, a first data signal is output from sense amplifier circuitry based on a first read command. With reference to FIG. 1, the sense amplifier circuitry 220 outputs a first data signal based on a first one or more of the memory cells of the memory bank circuitry 250 based on a first command. The first data signal is output to the selection circuitry 240. Outputting the first data signal includes activating one or more wordlines and driving one or more bitlines, as is described in greater detail above, to select one or more memory cells of the memory bank circuitries 250, and to receive data from the selected one or more memory cells. The first command corresponds to a first address.

At operation 720 of the method 700, a second data signal is output from buffer circuitry based on a second command. With reference to FIG. 2, the buffer circuitry 230 outputs a second data signal based on a second one or more of the memory cells of the memory bank circuitry 250 based on a second command. The second data signal is output to the selection circuitry 240. In one example, the second data is previously output from the sense amplifier circuitry 220 and loaded (stored) within the buffer circuitry 230 as is described in above.

At operation 730 of the method 700, a selected one of the first data signal and the second data signal is output from the selection circuitry. For example, the selection circuitry 240 selects the first data signal output from the sense amplifier circuitry 220 or the second data signal output from the buffer circuitry 230, and outputs the selected data signal. The selection circuitry 240 receives a control signal indicating which data signal to select. The control signal is associated with a command. For example, if the data associated with command is stored within the buffer circuitry, the control signal indicates to output the second data signal output from the buffer circuitry. If the data associated with command is stored within the sense amplifier circuitry, the control signal indicates to output the first data signal output from the sense amplifier circuitry. The data signal is output from the selection circuitry 240 and provided to a host device (e.g., the host device 120 of FIG. 1) as is described in greater detail above.

A row, or page, conflict includes recharging currently active memory cells of the memory device to activate other memory cells of the memory device. Such conflicts use a large number of cycles, increasing the latency of the memory device. As is described above, row, or page, conflicts are mitigated by including buffer circuitry within the memory device. The buffer circuitry is able to store the data associated with first active memory cells, while the sense amplifier circuitry reads data associated with second memory cells. The memory cells are deactivated (e.g., precharged) while the second memory cells are activated. The data associated with the first memory cells remains in the buffer circuitry while the data associated with the second memory cells are activated. Accordingly, data associated with multiple memory cells may be accessed without a row or page conflict occurring. Accordingly, the latency of a memory device is reduced, increasing the performance of the memory device.

While the foregoing is directed to specific examples, other and further examples may be devised without departing from the basic scope thereof, and the scope thereof is determined by the claims that follow.

What is claimed is:

1. A memory device comprising:
memory bank circuitry comprising memory cells;
sense amplifier circuitry coupled to the memory bank circuitry;
buffer circuitry coupled to an output of the sense amplifier circuitry; and
selection circuitry configured to receive a first data signal from the sense amplifier circuitry and a second data signal from the buffer circuitry, and output a selected one of the first data signal and the second data signal.

2. The memory device of claim 1, wherein the first data signal is associated with a first one or more of the memory cells and the second data signal is associated with a second one or more of the memory cells.

3. The memory device of claim 2, wherein the sense amplifier circuitry is configured to store data associated with a second one or more of the memory cells within the buffer circuitry.

4. The memory device of claim 2, wherein the first data signal is associated with a first read command and the second data signal is associated with a second read command.

5. The memory device of claim 1, wherein the sense amplifier circuitry is configured to store data associated with a third read command within the buffer circuitry.

6. The memory device of claim 1, wherein the buffer circuitry comprises row buffer circuitries, each of the row buffer circuitries is configured to store data associated with a data signal, and wherein the buffer circuitry is configured to output a data signal from one of the row buffer circuitries based on a read command.

7. The memory device of claim 1, wherein the sense amplifier circuitry is configured to refresh one or more of the memory cells and the selection circuitry is configured to output the second data signal from the buffer circuitry during at least partially overlapping periods.

8. The memory device of claim 1, wherein the buffer circuitry is configured to store a number of bits that is less than a number of bits within a page of the memory device.

9. A method comprising:
outputting, from sense amplifier circuitry of a memory device, a first data signal based on a first command, wherein the first data signal corresponds to a first one or more memory cells of the memory device;
outputting, from buffer circuitry of the memory device, a second data signal, wherein the second data signal corresponds to a second command, and wherein the second data signal corresponds to a second one or more of the memory cells of the memory device; and
outputting, from selection circuitry of the memory device, a selected one of the first data signal and the second data signal.

10. The method of claim 9 further comprising:
receiving the first command; and
outputting, from the selection circuitry, the first data signal based on receiving the first command.

11. The method of claim 9 further comprising:
receiving the second command; and
outputting, from the selection circuitry, the second data signal based on receiving the second command.

12. The method of claim 9 further comprising:
receiving a third command, wherein a target of the third command is a third one or more of the memory cells of the memory device;
outputting, from the sense amplifier circuitry, a third data signal associated with the third one or more of the memory cells;
storing the third data signal in the buffer circuitry; and
outputting, from the selection circuitry, the third data signal.

13. The method of claim 12 further comprising selecting one of the second data signal and the third data signal to be output from the buffer circuitry.

14. The method of claim 9 further comprising:
receiving a fourth command, wherein a target of the fourth command is a fourth one or more of the memory cells of the memory device;
outputting, from the sense amplifier circuitry, a fourth data signal associated with the fourth one or more of the memory cells;
receiving, at the selection circuitry, the second data signal from the buffer circuitry and the fourth data signal from the sense amplifier circuitry; and
outputting, from the selection circuitry, fourth data signal based on receiving the fourth command.

15. The method of claim 9 further comprising refreshing, via the sense amplifier circuitry, one or more of the memory cells, and, outputting, via the selection circuitry, the second data signal from the buffer circuitry during at least partially overlapping periods.

16. A computing system comprising:
a memory controller configured to output a first command and a second command; and
a memory device comprising:
sense amplifier circuitry configured to output a first data signal based on the first command and a second data signal associated with the second command;
buffer circuitry configured to store the second data signal based on receiving the second command; and
selection circuitry configured to receive the first data signal from the sense amplifier circuitry and the second data signal from the buffer circuitry, and output a selected one of the first data signal and the second data signal.

17. The computing system of claim 16, wherein the sense amplifier circuitry is configured to store data of a one or more memory cells of the memory device within the buffer circuitry.

18. The computing system of claim 16, wherein the sense amplifier circuitry is configured to store data associated with a third one or more of memory cells of the memory device and based on a third command within the buffer circuitry.

19. The computing system of claim 16, wherein the sense amplifier circuitry is configured to refresh one or more memory cells of the memory device and the selection circuitry is configured to output the second data signal from the buffer circuitry during at least partially overlapping periods.

20. The computing system of claim 16, wherein the buffer circuitry is configured to store a number of bits that is less than a number of bits within a page of the memory device.
